(19) United States
(12) Patent Application Publication
(10) Pub. No.: US 2020/0391793 A1
(43) Pub. Date: Dec. 17, 2020

(54) USE OF A SERVO MOTOR OF A POWER STEERING SYSTEM TO GENERATE TEST CYCLES ACCORDING TO A SPEED ASCERTAINING CYCLE

(71) Applicant: JTEKT EUROPE, Irigny (FR)

(72) Inventors: Matthieu LOUSSAUT, Tassin-la-Demi-Lune (FR); Christophe RAVIER, Saint Pierre de Chandieu (FR)

(73) Assignee: JTEKT EUROPE, Irigny (FR)

(21) Appl. No.: 16/770,778

(22) PCT Filed: Dec. 3, 2018
(86) PCT No.: PCT/FR2018/053087

§ 371 Date: Jun. 8, 2020

(30) Foreign Application Priority Data
Dec. 7, 2017 (FR) 1761763

(51) Int. Cl. B62D 5/04; B62D 3/12; B62D 15/02

(52) U.S. Cl. CPC B62D 5/0487; B62D 15/0235; B62D 5/0463; B62D 3/126

(57) ABSTRACT

A power steering system having at least one steering wheel, steering mechanism provided with rack, and at least one servo motor, the method having, outside steering phase during which power steering system is assigned to driving of vehicle to cause vehicle to follow trajectory which is determined as function of the situation of vehicle with respect to its environment, step (a) of automatically activating the servo motor, during which step computer is used to automatically generate and apply the servo motor, without requiring any external action on steering wheel, activation instruction that follows one or more cycles referred to as pre-established exploration cycles in order to measure, during at least one exploration cycle or at the end of at least one exploration cycle, at least one indicator parameter which is specific to response by power steering system to automatic activation of servo motor and which is characteristic of desired property.

The present invention concerns the characterization methods intended to empirically determine at least one property of a power steering system, such as for example the position of the end-of-stroke stops of a steering rack, during the fine-tuning or the calibration of said system in factory.

The known characterization methods require a human operator installing the power steering system on a test bench, then the latter maneuvering the steering wheel according to pre-established special maneuver cycles so that sensors and recorders equipping the test bench could observe the reactions of the steering system and measure the indicator parameters which then allow quantifying the pursued property.

Of course, such manual maneuvers are sometimes quite tedious, and often relatively inaccurate, to the extent that the operator cannot exert an accurate speed or force setpoint, and in particular a constant value setpoint, in a reliable and repeatable manner, or else he could for example be mistaken about the direction of maneuver during a cycle, which may distort the estimate of the pursued property.

Moreover, while it is possible, in absolute terms, to consider replacing the operator with a robotized arm that actuates the steering wheel, such a solution is particularly complex and expensive to implement, in particular because it is necessary, at each test, to install and couple the robotized arm to the steering wheel, and to materially reconfigure the robotized arm and the test bench according to the model of the tested steering system.

Consequently, the objects assigned to the invention aim at overcoming the aforementioned drawbacks and at providing a method for characterizing a power steering system which allows for a quick, reliable and low-cost characterization of said power steering system.

The objects assigned to the invention also aim at providing a new method for characterizing a power steering system which has a great versatility, as said method adapts in a simple manner to many models of power steering systems and/or allows completely characterizing several properties of the same power steering system.

The objects assigned to the invention are achieved by means of a method for characterizing a power steering system intended to empirically determine at least one property of said power steering system, called «pursued property», said power steering system comprising at least one heading definition device, such as a steering wheel, which allows defining the orientation, called «steering angle» of the power steering system, a steering mechanism provided with at least one movable member, such as a rack, whose position adapts so as to correspond to the selected steering angle, as well as at least one assist motor arranged so as to be able to drive said steering mechanism, said method being characterized in that it comprises, besides a piloting phase during which the power steering system is dedicated to driving of a vehicle in order to make said vehicle follow a path that is determined according to the situation of said vehicle with respect to its environment, a step (a) of automatically activating the assist motor, during which a calculator is used to automatically generate and apply to the assist motor, without requiring any external action on the heading definition device, an activation setpoint which follows one or several pre-established cycle(s) called «exploration cycles», a measurement step (b), according to which is measured, during the exploration cycle(s) or on completion of said exploration cycle(s), at least one physical parameter, called «indicator parameter», which is specific to the response supplied by the power steering system to the automatic activation of the assist motor and which is characteristic of the pursued property, then an analysis step (c), during which the pursued property is quantified from the measurement(s) of the indicator parameter.

Advantageously, the invention thus uses the assist motor itself as a (unique) means to activate the steering mechanism according to the selected exploration cycle(s), without it being necessary to use an auxiliary drive means, and in particular an auxiliary motor, external to the steering system.

Thus, an operator or a robotized arm is no longer necessary.

Furthermore, the automation of the exploration cycles advantageously allows applying to the assist motor, during the phases where the steering system is characterized, particularly accurate setpoints, much more accurate than during manual maneuvers, and in particular predetermined speed, acceleration or force setpoints that are constant over predetermined periods or over displacement distances of the movable member, which allows accurately measuring the indicator parameter(s), without the activation of the power steering system constituting by its very nature a potential source of error that would be related to an excessive and uncontrolled variability of the setpoint with respect to the target ideal exploration cycle.

Hence, the characterization of the pursued property is particularly accurate and repeatable.

Furthermore, the invention allows in particular equipping the power steering system, irrespective of the model of said system, with an onboard calculation module which contains a complete set of characterization functions, for example in the form of a library file stored in a non-volatile memory of said module, such that the power steering system will be intrinsically provided with the tools that are necessary to the characterization thereof, and more generally to the characterization of several ones of its properties.

Hence, the fine-tuning and the calibration of said power steering system will be greatly facilitated.

Other objects, features and advantages of the invention will appear in more detail on reading the following description, as well as using the appended drawings, provided as an illustrative and non-limiting example, among which:

FIG. 1 illustrates, according to a schematic view, a power steering system.

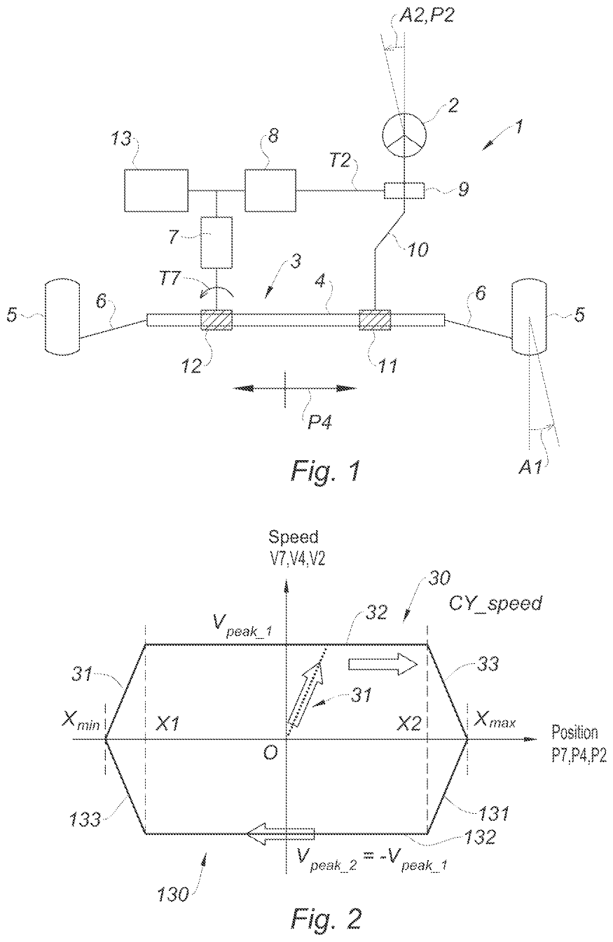

FIG. 2 illustrates an example of a speed exploration cycle representing the evolution of a speed setpoint according to which the assist motor is servo-controlled as a function of the position of a movable member of the steering mechanism.

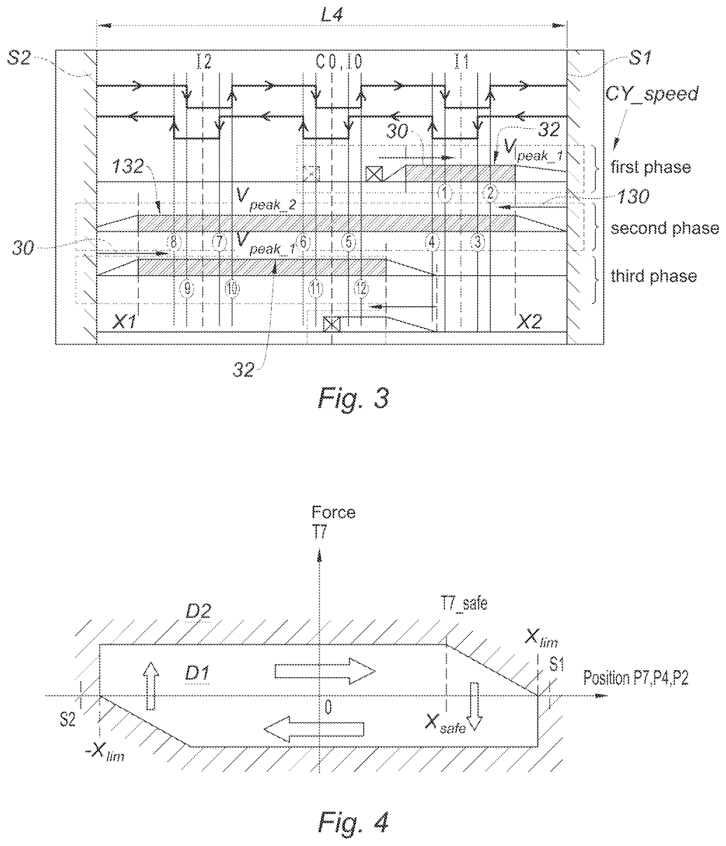

FIG. 3 illustrates the application of a speed exploration cycle to the determination of the positions of end-of-stroke stops of the steering mechanism as well as the index positions each corresponding to a complete revolution of the steering wheel.

FIG. 4 illustrates a safeguarding function which, by superimposing where needed to the exploration cycles, allows limiting the torque generated by the assist motor when the steering mechanism approaches the end-of-stroke stops.

The invention concerns a method for characterizing a power steering system 1 intended to empirically determine at least one property of said power steering system 1, specific to said system, called «pursued property».

As shown in FIG. 1, said power steering system 1 comprises at least one heading definition device 2 which allows defining the orientation, called «steering angle» A1, of the power steering system.

Preferably, the heading definition device 2 will comprise a steering wheel 2 which enables a driver (human) to freely define said steering angle A1 so as to ensure a manual piloting of a vehicle equipped with the power steering system 1.

Said steering system also comprises a steering mechanism 3 provided with at least one movable member 4, such as a rack 4, whose position P4 adapts so as to correspond to the selected steering angle A1.

For convenience, the movable member 4 may therefore be assimilated to a rack in what follows.

In a manner known per se, said movable member 4, and more particularly the rack 4, may preferably be mounted movable and guided in translation within a steering casing.

Thus, the steering mechanism 3 allows modifying the orientation of an orientable member 5, such as a steered wheel 5, displaced by the rack 4, in order to direct a vehicle on which said power steering system 1 is embedded.

In a manner known per se, the steering mechanism 3 may comprise steering tie rods 6 each linking one end of the rack 4 to a yaw-orientable steering knuckle and carrying the corresponding steered wheel 5.

The power steering system 1 also comprises at least one assist motor 7 arranged so as to be able to drive said steering mechanism 3.

Preferably, said assist motor 7 will consist of an electric motor, with two directions of operation, so as to be able to drive the steering mechanism 3 indifferently to the left or to the right, for example a brushless motor.

Although the use of a linear motor 7 is not excluded, a rotary motor 7 will be preferred.

The assist motor 7 is placed, through a calculator comprising a first onboard module 8, that is to say integrated to the system 1, called «assist module» 8, under the dependence of the heading definition apparatus 2.

Preferably, the heading definition apparatus 2 may serve to define a steering angle setpoint A2, which may typically be defined, in the case where the apparatus 2 comprises a steering wheel 2 or is formed by a steering wheel 2, by the angular position P2 of said steering wheel 2.

Alternatively or complementarily to the supply of a steering setpoint A2, the heading definition apparatus 2 may supply a force datum T2, called «steering wheel torque», which corresponds to the force exerted by the driver on said heading definition apparatus 2, and more particularly to the torque exerted by the driver on the steering wheel 2.

Said steering wheel torque T2 may be measured by a torque sensor 9 associated to the steering wheel 2.

According in particular to the steering angle setpoint A2 and/or where appropriate according to the «steering wheel torque» T2 exerted by the driver on said heading definition apparatus 2, the assist module 8 defines, according to an assist law stored in said assist module 8, an assist force setpoint (assist torque setpoint) T7 applied thereby to the assist motor 7, in order to make the actual steering angle A1 of the system 1, and consequently the yaw angle of the wheels 5, coincide with the orientation defined by the heading definition apparatus 2.

Of course, other parameters, and in particular dynamic parameters of the vehicle, such as the longitudinal speed of the vehicle, may be taken into consideration by the assist law.

It should be noted that the invention may preferably apply to a power steering system within which the steering wheel 2 is mechanically linked to the rack 4 and therefore mechanically linked, at least indirectly, to the assist motor 7, for example through a steering column 10 carrying said steering wheel 2 and provided with a pinion 11 which meshes on the rack 4.

In this manner, the steering wheel 2 is an integral part of the steering mechanism 3, and can transmit a manual steering force and/or a steering movement to the movable member (rack) 4, and conversely, be driven by the assist motor 7.

Alternatively, it is quite possible to consider applying the invention to a power steering system called «steer-by-wire», within which there is no drive mechanical linkage between the steering wheel 2 and the movable member (rack) 4 driven by the assist motor 7, but only an electric link which transmits the steering angle setpoint A2 and/or the steering wheel torque information T2 to the assist module 8 which, in turn, servo-controls the assist motor 7.

The assist motor 7 may be coupled to the rack 4 by any suitable mechanism, and in particular by a motor pinion 12, possibly distinct from the pinion 11 of the steering column, and which directly meshes on the rack 4, as illustrated in FIG. 1, or by a ball screw, or else through a reducer placed on the steering column 10 so as to form a so-called «single-pinion» mechanism.

Whether considering a mechanical linkage steering or a steer-by-wire, the heading definition apparatus 2 intervenes during a phase called «piloting phase», during which the power steering system 1 is effectively dedicated to driving of a vehicle, in order to make said vehicle follow a path that is determined according to the situation of said vehicle with respect to its environment.

According to the invention, the method comprises, besides such a piloting phase, that is to say at the time where the steering system 1, and more generally the vehicle, is not in a traffic situation, and that it is not therefore necessary to take into account the environment of said vehicle to define a vehicle path adapted to such an environment, or to necessary comply with a particular path to ensure safety of the vehicle and of its occupants, a step (a) of automatically activating the assist motor 7, during which a calculator 13 is used to automatically generate and apply to the assist motor 7, without requiring any external action on the heading definition device 2, an activation setpoint which follows one or several pre-established cycle(s) called «exploration cycles» CY, a measurement step (b), according to which is measured, during the exploration cycle(s) CY or on completion of said exploration cycle(s) (CY), at least one physical parameter, called «indicator parameter», which is specific to the response supplied by the power steering system 1 to the automatic activation of the assist motor 7 and which is characteristic of the pursued property, then an analysis step (c), during which the pursued property is quantified from the measurement(s) of the indicator parameter.

Although it is not excluded to punctually use a calculator 13 external to the power steering system 1, that would be electrically connected to said system 1 when it is desired to proceed with the characterization of the latter, said calculator 13 may preferably be an integral part of the power steering system 1, and therefore of the vehicle equipped with said system 1, and form to this end a second onboard module, called «characterization module» 13.

Preferably, the first module, namely the assist module 8 used for assisting steering during the piloting phase, and the second module, namely the characterization module 13 intended to monitor the automated process of characterizing the power steering system 1 off the piloting phase will co-exist within the same calculator onboard the vehicle.

Advantageously, the invention allows intrinsically using the assist motor 7 embedded in the power steering system 1 as an exclusive drive source to drive the steering mechanism 3 during the characterization, without requiring an external active movement source, such as the manual force of an operator or an external additional motor, that would be distinct from the assist motor 7 (and for example integrated to a robotized arm).

Hence, more generally, the characterization according to the invention may advantageously be carried out without it being necessary to mechanically act in an active way, whether manually or by an external motor, on the power steering system 1, and more particularly on the steering mechanism 3, from the outside, and more particularly without it being necessary to actuate, whether manually or by an external motor, any of the movable mechanical members, such as the steering wheel 2, an apparent end of the rack 4, or possibly a steering tie rod 6 or a wheel 5 linked to said rack 4, that form a mechanical interface between said power steering system 1, respectively said steering mechanism 3, and the outside thereof.

Hence, the actuation of the steering mechanism 3 for the characterization according to the invention may be carried out in a standalone, easy manner and at a lesser cost, by exclusively exploiting drive means (assist motor 7), and where appropriate control means (characterization module 13), that are intrinsically present in the power steering system 1.

Moreover, it should be noted that it is possible to provide for using one or several passive external load(s), such as for example blocking wedges, springs and/or dampers, that are coupled to either one or both of the mechanical interfaces of the power steering system 1 (steering wheel 2 or ends of the rack 4, for example) in order to simulate a particular behavior of the steering system 1 and thus access to the pursued property.

Nonetheless, these external loads will be passive, that is to say, unlike the assist motor 7, they will not intrinsically bring in energy to the power steering system, but will rather serve to dissipate all or part of the energy imparted to the steering mechanism 3 by said assist motor 7 or to modify the distribution of said energy over time and through said steering mechanism 3.

As indicated hereinabove, the characterization method according to the invention takes place off any piloting phase of a vehicle, in a test situation that may be qualified as “virtual” situation, since said situation does not require complying with a particular path or with a particular dynamic behavior of the vehicle, and therefore allows characterizing the power steering system 1 as such, irrespective of the influence of the vehicle, by de-correlating the use of said power steering system 1 from the use of the vehicle itself, and consequently without imposing on the characterization method restrictions related to safety of said vehicle or of the occupants of the latter.

Thus, the method according to the invention will be particularly suited to the characterization in factory, off traffic, typically on a test bench, of a vehicle equipped with a power steering system 1, or even of a power steering system 1 alone, before assembly of said system 1 on a vehicle, and for example of a power steering system 1 on which the wheels 5, and where appropriate the steering tie rods 6 have not yet been installed.

Since step (a) of automatic activation for the characterization takes place off a vehicle piloting phase, it is advantageously possible to control the assist motor 7 by means of an exploration cycle CY, and therefore of an activation setpoint, whose nature, form and duration, defined according to a predetermined activation diagram («pattern»), will be arbitrarily and freely selected, so as to be able to determine the pursued property, in an optimum manner, and without having to comply with a compulsory path of a vehicle, and in particular without having to take into consideration safety of the vehicle, of the occupants of said vehicle, or of the persons or objects present in the environment of said vehicle.

In practice, it will therefore be possible to define and apply the exploration cycles CY, and more generally the activation setpoint applied to the assist motor 7 during the characterization method, without the need for acquiring (and in particular measuring) or taking into consideration parameters representative of the dynamics specific to the vehicle with respect to its environment, that is to say parameters representative of the behavior specific to the vehicle within a reference frame external to said vehicle, amongst which in particular the longitudinal speed of the vehicle, the lateral acceleration of said vehicle, the yaw speed of said vehicle, or the distance of the vehicle from an obstacle or from an external reference (for example a white line delimiting the traffic lane) detected within said external reference frame.

In this manner, said exploration cycles will not be subjected to any restriction related to such parameters representative of the dynamics of the vehicle, and, in practice, will not therefore require for their definition and their application, any external information input related to such parameters, and in particular any visual information input.

Thus, it will be possible to activate the assist motor 7 without having to input information concerning parameters representative of the dynamics of the vehicle within its environment, which information input would be carried out either by the senses (in particular tactile and visual) of a human driver, who would react afterwards to this information by manually actuating the steering wheel 2, or through an automatic acquisition process (for example by means of a camera or a radar, in particular laser, infrared or ultrasonic) which would be implemented by an automatic piloting module.

At most, said exploration cycles may possibly be dimensioned so as to comply with some material limitations inherent to the design of the power steering system 1 itself, such as for example the maximum torque that the assist motor 7 can output (and therefore the maximum electric current that said assist motor 7 can tolerate without damage).

As illustrated in FIGS. 2 and 3, the exploration cycle may preferably include at least one sign change, which corresponds to a reversal of the direction of activation of the assist motor 7, so as to activate said assist motor 7 to the right, and then to the left (or vice versa).

Thus, a so-called «elementary» exploration cycle may preferably comprise a positive alternation and a negative alternation.

Nonetheless, it is of course possible to alternatively use an elementary cycle comprising one single alternation, with a constant sign, for example positive, in order to load the assist motor 7 only in one direction, to the right or on the contrary to the left, if this is enough to define the pursued property.

Of course, each elementary exploration cycle CY may be repeated as many times as necessary, preferably identically, without exceeding a predetermined number of iterations Ni.

Where appropriate, the repetition of the exploration cycles CY will allow multiplying, during the successive cycles, the measurements of the same indicator parameter, for example at the rate of at least one, and even exactly one, measurement of said indicator parameter per cycle.

By thus using a plurality of successive measurements of the same indicator parameter over several cycles to quantify the pursued property, and for example by using to this end an arithmetic average or a weighted average of the different measurements of said indicator parameter over several cycles, and even a selection of said measurements excluding values deemed to be doubtful, it is advantageously possible to improve the accuracy and the reliability of the analysis step (c), during which the pursued property is quantified from said indicator parameter, respectively from said average.

Of course, during the measurement step (b), the reactions of the power steering system 1, and more particularly of the steering mechanism 3, to the mechanical constraints created by the activation of the assist motor 7, are observed by measuring and possibly recording as many indicator parameters as necessary to determine the pursued property from said observed response.

In particular, it is possible to measure, as needed, one or several indicator parameter(s) among: the position P7 (and therefore the displacements) of the shaft of the assist motor 7, the position (and therefore the displacements) P4 of the movable member 4 (rack) or the position P2 (and therefore the displacements) of the steering wheel 2, preferably expressed in the reference frame of the assist motor 7, the speed P7′, P4′, P2′ and in particular the angular speed (preferably expressed in the reference frame of the motor 7, while taking into consideration the possible mechanical transmission ratios) of either one of these components 7, 4, 2, the force T7 delivered by the assist motor 7, the steering wheel torque T2, or a resisting force T4 exerted by an external element on the movable member (rack) 4 against the assist motor 7.

For convenience of the description, it is possible to add in what follows the suffix «_mes» to explicitly refer to an indicator parameter (measured or assessed) associated to a given quantity, in particular when it is necessary to explicitly differentiate the effective value measured by said indicator parameter from a corresponding setpoint value. Nonetheless, for convenience of the description, it is generally possible to assimilate the indicator parameter (measured effective value) to the corresponding setpoint.

Preferably, the method allows determining at least one pursued property, and even more preferably several (at least two) pursued properties, amongst:
a friction value specific to the steering system 1 and which resists the displacement of a movable member 4 of said steering system, for example of a rack 4,
a measurement of the stroke of a steering rack, an identification of the positions of the end-of-stroke stops S1, S2 of the steering mechanism 3, an identification of the central position CO of the steering mechanism 3, located halfway between the end-of-stroke stops and substantially corresponding to a straight line driving configuration,
an identification of one or several index position(s) 10, 11, 12, signaled by an index which marks a unique reference position throughout the same complete revolution of a steering wheel 2,
a sound level generated by the assist motor 7 and/or the steering mechanism 3,
the identification of positions called «sticking points» at the level of which the steering mechanism 3 has a resistance to the displacement, and in particular a viscous resistance, higher than a predetermined threshold.

These different possibilities provided by the invention will be detailed hereinafter.

According to a possibility of the invention, it is possible, during the automatic activation step (a), to apply a speed exploration cycle CY_speed or a succession of several speed exploration cycles CY_speed, where each speed exploration cycle CY_speed servo-controls the speed of the assist motor 7 and/or of a selected movable member 4, 2 of the steering mechanism 3.

The speed exploration cycle CY_speed defines a speed setpoint V7=P7′=dP7/dt, respectively V4=P4′=dP4/dt or V2=P2′=dP2/dt, and more particularly an angular speed, that the assist motor 7 or, respectively, the selected movable member 4, 2 (for example the rack 4, or the steering wheel 2), must reach and follow.

An example of an elementary speed exploration cycle is illustrated in FIG. 2, with the position P7, P4, P2 of the servo-controlled component in abscissa, preferably expressed in the reference frame of the assist motor 7, and the speed setpoint V7, respectively V4 or V2 of the servo-controlled component, in ordinates.

Said elementary speed exploration cycle CY_speed will preferably comprise a first alternation 30, herein a positive alternation 30, during which the assist motor 7 drives the steering mechanism 3 to the right and then, preferably, a second alternation 130, herein a negative alternation 130, during which the speed V7, V4, V2 is reversed, so that the assist motor 7 drives the steering mechanism 3 to the left (or vice versa).

The elementary speed exploration cycle CY_speed may possibly include one single alternation, with a constant sign. Nonetheless, in case of repetition of the elementary cycles, it is preferable to provide for (at least) two alternations 30, 130, which allow executing a back-and-forth movement, in order to bring the steering mechanism 3 substantially back into its original position, preferably into its central position CO, at each cycle.

For illustration, an alternation 30, 130 may extend from a start position (herein 0, or Xmin for the positive alternation 30, Xmax for the negative alternation 130) up to an end position (Xmax for the positive alternation 30, Xmin for the negative alternation 130), and may comprise an acceleration phase 31, 131, preferably in the form of a ramp (which evolves linearly with the position), during which the speed setpoint V7, V4, V2 increases, in absolute value, so as to pass from a zero value to a peak speed value Vpeak_1, Vpeak_2, then a deceleration phase 33, 133 preferably in the form of a ramp (which evolves linearly with the position), during which the speed setpoint decreases until reverting to zero.

Preferably, we choose Vpeak_2=−Vpeak_1, so as to carry out a symmetrical servo-control to the left and to the right.

Preferably, the speed exploration cycle CY_speed, and more particularly the first alternation 30 and/or the second alternation 130, comprises at least one plateau 32, 132 which extends between a plateau start position X1 and a plateau end position X2 (or vice versa, for the second alternation 130).

According to this plateau 32, 132, the servo-controlled speed V7, V4, V2, and more preferably the speed of the steering wheel V2, is constantly and automatically maintained, from the plateau start position X1 up to the plateau end position X2, in the vicinity of a plateau nominal value with an error less than 20%, preferably less than 10%, or less than or equal to 5% of said plateau nominal value.

Preferably, said plateau nominal value 32, 132 corresponds to the peak speed Vpeak_1, Vpeak_2.

Advantageously, an automated servo-control of the speed setpoint in accordance with the plateau 32, 132 allows maintaining a regular speed V7, V4, V2, substantially constant over the entire range of positions [X1; X2] occupied by said plateau 32, 132, at a higher accuracy (and therefore a lesser error) than in the case of a manual activation where the speed V7, V4, V2 is imparted by the action of the operator (for indication, a manual actuation may cause an error greater than 50% with respect to the target speed nominal value).

More generally, it should be noted that the speed exploration cycle CY_speed allows ensuring an execution of the speed setpoint V7, V4, V2 with an error less than 20%, preferably less than 10%, or less than or equal to 5% of said speed setpoint value.

Thus, the method according to the invention ensures a better detection of the characteristic phenomena of the pursued property, with a finer resolution and a better reliability than in the case of manual maneuvers.

Furthermore, the regularity of the speed V7, V4, V2 ensures an excellent repeatability of the detection conditions, and therefore of the conditions of measurement of the indicator parameter(s).

Preferably, on either side of the plateau 32, there are respectively the acceleration phase 31, 131, which precedes the plateau 32 and allows accessing thereto, then the deceleration phase 33, 133, which follows the plateau 32 and allows leaving the latter.

Preferably, and regardless of the respective lengths of the acceleration 31, 131 and deceleration 33, 133 phases, the plateau hold phases 32, 132 may be longer than said acceleration, respectively deceleration, phases when it is primarily desired to study the response of the power steering system 1 at constant speeds V7, V4, V2.

Of course, depending on the pursued property, it is possible to adapt the stroke length covered by the plateau 32, 132, and in particular extend the plateau 32, 132 over a stroke length that is as long as possible.

For indication, the plateau 32, 132 may continuously extend over at least 20%, preferably at least 30%, at least 40%, preferably at least 50%, at least 60%, at least 70%, or even at least 75% of the stroke provided between the start position 0, Xmin and the end position Xmax, and/or, over at least 20%, preferably at least 30%, at least 40%, preferably at least 50%, at least 60%, at least 70%, or even at least 75% of the available stroke between the start position 0, Xmin, Xmax of the cycle and the corresponding end-of-stroke stop S1, S2 in the considered direction of displacement, and where appropriate, of the maximum stroke L4 which separates the first end-of-stroke stop S1 from the second end-of-stroke stop S2.

Preferably, the extent of the plateau 32, 132 will further be smaller than or equal to 95%, 90%, or 85% of the maximum stroke L4, respectively of the available stroke in the considered direction of displacement, respectively of the available stroke provided between the start position 0, Xmin and the end position Xmax, and that so as to keep the rest of the stroke for the acceleration 31, 131 and deceleration 33, 133 phases, and thus provide for a safety margin with respect to the end-of-stroke stops S1, S2 and/or the selected end-of-stroke positions Xmin, Xmax.

Preferably, a speed exploration cycle CY_speed may preferably be used, as illustrated in FIG. 3, to identify:
at least one position of a first end-of-stroke stop S1 of the steering mechanism 3,
and/or a position of a second-end-stroke stop S2 of said steering mechanism opposite to the first one,
and/or the maximum stroke L4 of the movable member 4, which maximum stroke L4 corresponds to the distance between said first and second end-of-stroke stops S1, S2: L4=S1−S2,
and/or the central position CO of said movable member, said central position CO being located halfway (L4/2) between said end-of-stroke stops S1, S2.

To this end, during a first phase, the speed exploration cycle CY_speed applies a non-zero speed setpoint V7, V4, V2, in a first direction (herein to the right in FIG. 3, according to a first alternation 30), so as to drive said steering mechanism 3 until the steering mechanism 3 is stopped by the first end-of-stroke stop S1.

The abutment may be detected when it is cumulatively observed, for a duration equal to or longer than a predetermined duration threshold:
on the one hand, an actual speed indicator parameter V7_mes, V4_mes, V2_mes lower than a predetermined speed threshold, close to zero,
and on the other hand, a force indicator parameter T7_mes, T4_mes, T2_mes (representative of the force, and more particularly of the torque T7, exerted by the assist motor 7, respectively of the force exerted on the rack 4 or on the steering wheel 2 equal to or higher than a predetermined force threshold.

The value of the position indicator parameter P7_mes, P4_mes, P2_mes at the time of abutment will provide the position of the end-of-stroke stop S1.

The second end-of-stroke stop S2 may be detected in a similar way during a second phase, where the speed exploration cycle CY_speed, by respectively applying a non-zero speed setpoint V7, V4, V2, drives the steering mechanism 3 in a second direction opposite to the first direction, until said steering mechanism 3 is stopped by said second end-of-stroke stop S2.

The maximum stroke L4 and the central position CO will be deducted from the knowledge of the positions of each of the two end-of-stroke stops S1, S2.

Advantageously, the use of a speed exploration cycle CY_speed allows approaching the end-of-stroke stops S1, S2 at a servo-controlled speed V7, V4, V2 that is moderate, so as to be lower than a predetermined critical speed threshold. To this end, the plateau speed (peak speed) Vpeak_1, Vpeak_2 will preferably be lower than said critical speed threshold.

According to an even more preferred possibility, the speed exploration cycle CY_speed will be designed so that the abutment on the end-of-stroke stop S1, S2 occurs during a deceleration phase 33, 133.

Thus, any brutal mechanical impact, and also any damaging overcurrent, at the time of blocking of the steering mechanism 3 by the stop, and therefore during blocking of the assist motor 7, will be avoided.

Furthermore, the automatic speed servo-control allows ensuring that torque disturbances (rapid rises) actually correspond to an abutment, and not to unintentional (manual) fluctuations of the speed setpoint which would cause fluctuations of the steering assist.

According to a quite similar principle, which may constitute an invention on its own, a speed exploration cycle may be used to determine one or several index position(s) 10, 11, 12.

More particularly, when the heading definition device 2 comprises a steering wheel 2 whose rotation is related to the displacement of the steering mechanism 3, and said steering wheel 2 is provided with an index, which marks a unique reference position throughout a complete revolution of said steering wheel, the method, and more particularly the speed exploration cycle CY_speed, may be used to identify, in a reference frame associated to the assist motor 7, one or several positions 10, 11, 12 of passage of the steering wheel through said index, as illustrated in FIG. 3.

For example, the index may be formed by a movable magnetic element, such as a permanent magnet placed on the steering wheel 2 or on the steering column 10, and which is brought alternately close to and away from a fixed sensor, such as an induction coil, by the rotation of the steering wheel 2.

As illustrated in the top portion of FIG. 3, each index crossing generates a pulse, comprised between a rising edge, triggered when approaching the index, and a falling edge, resulting from getting away from the index (or vice versa, depending on the selected sign convention).

In practice, the pulse may preferably have a substantially Gaussian shape (bell curve), whose mid-height width corresponds to the spacing (position difference) between the (rising, and respectively falling) edges of said pulse, as these are detected, and illustrated in FIG. 3.

Preferably, the power steering system 1 will be dimensioned so that it is possible to make the steering mechanism 3, and more particularly the rack 4, pass from its first end-of-stroke stop S1 to its second end-of-stroke stop S2, in three steering wheel revolutions, such that the overall stroke L4 of said mechanism 3 will cover three passages 10, 11, 12 through the index.

In any case, preferably, the mechanism 3 will therefore have, as illustrated in FIG. 3, at least, or exactly, one central index position 10, corresponding to the central revolution of the steering wheel 2, a right index position 11, corresponding to the steering wheel revolution to the right, and a left index position 12 corresponding to the steering wheel revolution to the left.

For this application to the detection of index positions, the speed exploration cycle CY_speed is preferably defined so as to create a plateau 32, 132 of the rotational speed V2 of the steering wheel, as described hereinabove.

The plateau start 0, X1 and plateau end X2 positions are selected such that the plateau 32, 132 covers a range of positions that is large enough to perform at least one and preferably at least two passage(s) through the index in the same direction of displacement.

In other words, the plateau 32, 132 makes the steering mechanism 3, and more particularly the steering wheel 2, cover a stroke which corresponds to more than one complete revolution of the steering wheel 2, or more than two complete revolutions of the steering wheel 2 in the same direction, and that so as to cross at least once, and preferably at least twice, the index in the considered direction.

Advantageously, crossing the index at a substantially constant, or strictly constant, speed V2 in accordance with the plateau 32, 132, allows obtaining very sharp (rising and falling) edges, and pulse widths (distance between the rising edge and the falling edge located on either side of the index position) that are substantially constant from one pulse to another.

In FIG. 3, the circled reference numerals bearing the numbers 1 to 12 correspond to the positions and to the order of acquisition of the rising edges (odd reference numerals) and the falling edges (even reference numerals) during the cycle.

Preferably, the speed exploration cycle CY_speed intended to spot the index positions 10, 11, 12 will comprises (at least) two alternations 30, 130, in order to cross each index position 10, 11, 12 in two opposite directions.

Indeed, it is possible to increase the accuracy of assessment of an index position 10, 11, 12 using, to define said index position, two edges of the same kind (for example two rising edges, or two falling edges), relating to the same index position but each acquired in a different passage direction.

When carried out a large number of times, the speed exploration cycle CY_speed may enable a robustness statistical study on the accuracy of measurement of the position of the edges.

More particularly, it is possible to consider that the position of a considered index 10, 11, 12 corresponds to half the distance that separates two edges that are of the same kind (that is to say two rising edges, or two falling edges) but each corresponding to opposite passage directions.

As illustrated in FIG. 3, in order to cover in each of the two (left and right) directions the stroke useful for the detection of all index positions 10, 11, 12, the speed exploration cycle CY_speed may comprise not only a first displacement phase (herein to the right), corresponding to a first alternation 30, and a second displacement phase (herein to the left), corresponding to a second alternation 130, but also a third displacement phase, corresponding to a new alternation 30 (herein to the right), complementary (with reference to the covered stroke length) with the first alternation 30 performed during the first phase.

It should also be noted that it advantageously possible to use, in a combined manner, one single speed exploration cycle CY_speed, such as that illustrated in FIG. 3, to identify, during said cycle, both the index positions 10, 11, 12 and the positions of the end-of-stroke stops S1, S2.

Finally, it should be noted that, for convenience of the description, in FIG. 3, the central position CO of the steering mechanism 3 is coincident with the central index 10, bearing in mind that, in practice, there is generally an offset between said central position CO and the central index 10, that the exploration cycle actually allows identifying.

According to another variant of application, the method, and more particularly the speed exploration cycle CY_speed, may be used to identify an acoustic property of the power steering system 1.

To this end, during the measurement step (b), and while the speed exploration cycle is applied, a noise indicator parameter, representing the sound level of the assist motor 7 and/or of the steering mechanism 3, is measured for example by means of a microphone located at a predetermined distance from said assist motor 7, possibly outside the steering casing to take into account a possible soundproofing conferred by said casing.

Preferably, the sound level will be measured during a plateau hold phase 32, 132, as described hereinabove, during which the servo-controlled speed V7, V4, V2, and more particularly the speed V7 of the shaft of the assist motor 7, is substantially constant.

Preferably, said plateau phase 32, 132 will be unique and continuous during the considered alternation 30, 130 so as to maximize the duration, and therefore the reliability of the measurement.

For example, the used peak speed Vpeak_1 may be selected between 50% and 90%, or 100% of a reference speed called «no-load speed», measured through tests, and corresponding to the maximum speed that the assist motor 7 can reach under predetermined arrangement and load conditions of the power steering system 1 (for example when the system 1 simply corresponds to a «bare» mechanism, without the steering tie rods 6 and the wheels 5).

According to another variant of application, the speed exploration cycle CY_speed may be used to identify a dynamic property of the power steering system amongst:
the existence of one or several possible stick point(s),
a value of an internal friction of the steering mechanism and affecting the displacement of the movable member.

To this end, during the measurement step (b), while applying the speed exploration cycle, a force indicator parameter T7_mes, representing the force, and more particularly the torque, supplied by the assist motor 7, is measured.

Thus, during the analysis step (c), it is possible to identify a sticking point when it is detected that the force indicator T7_mes reaches or exceeds a predetermined warning threshold, which indicates that the steering mechanism 3, and more particularly the movable member 4, opposes an abnormally high resistance to its displacement at the selected setpoint speed V7, V4, V2.

Preferably, in order to identify possible sticking points, a constant speed setpoint V7, V4, V2 will be selected using to this end a plateau phase 32, 132 as described hereinabove.

Advantageously, the regularity of the speed V7, V4, V2 throughout the plateau 32, 132 allows recognizing immediately the disturbances caused by changes in the resistant torque that resists the displacement of the speed servo-controlled component (the motor 7, a movable member such as the rack 4 or the steering wheel 2), and ensuring that the disturbances thus observed, and in particular the assist torque bursts that are necessary to ensure the maintenance of the speed on passage through the sticking points (and which are noticeable via a force indicator parameter T7_mes, T2_mes), are actually due to a cause other than an unintentional fluctuation of the speed setpoint.

Respectively, during the analysis step (c), it is possible to assess the friction from the drop of the force indicator T7_mes at the time of a steering reversal, that is to say at the time when the sign of the speed (and therefore the direction of displacement) of the mechanism 3 is reversed.

More particularly, the friction may be considered, in particular with regards to Coulomb's law, as the middle of the drop height that separates on the one hand the force, and more particularly the motor torque T7, that is exerted on the steering mechanism 3 just before the steering reversal to drive said mechanism in a first direction (for example to the right), and on the other hand, the force, and more particularly he motor torque T7, that is exerted on the steering mechanism 3 just after the steering reversal to drive said mechanism in a second direction (for example to the left) opposite to the first direction.

It should be noted that in order to measure the friction, a low cycle amplitude, and consequently a small range covered between the start position Xmin and the end position Xmax is enough. Thus, said amplitude may be equal to or smaller than 80 degrees of rotation of the steering wheel 2, that is to say for example enable a maximum movement of the steering wheel 2 comprised between Xmax=+40 degrees and Xmin=−40 degrees on either side of the central position CO.

Moreover, the characterization method may also include, during the activation step (a), a safeguarding substep (a1), during which the motor torque setpoint T7 applied to the assist motor 7 is clipped in order to keep said torque setpoint below (in absolute value) a predetermined safety threshold T7_safe, said safety threshold T7_safe being adjusted, and more particularly reduced, when approaching a limit position Xlim that should not be exceeded, and for example when approaching an end-of-stroke stop S1, S2.

To this end, a function, called «safeguarding function», is used which defines, as illustrated in FIG. 4, in a reference frame associating a steering wheel torque T7 (in ordinate) to a value representative of the position P7, P4, P2 of the steering mechanism, and more preferably representative of the position P4 of the rack 4, on the one hand an authorized domain D1 (blank in FIG. 4) and, on the other hand, a prohibited domain D2 (hatched in FIG. 4), whose boundary corresponds to the safety threshold T7_safe.

It should be noted that, in each considered direction of displacement (to the right, respectively to the left), the safety threshold T7_safe is lowered (that is to say its absolute value decreases), from a safety position Xsafe that precedes the limit position Xlim in the considered direction of displacement, and preferably until becoming zero when said limit position Xlim is reached.

To this end, the safeguarding function may form a ramp decreasing from the safety position Xsafe down to the limit position Xlim.

Thus, it is possible to force a progressive slow-down of the steering mechanism 3 to avoid exceeding the limit position Xlim, and more particularly hitting against the stop S1 (when the used exploration cycle does not aim at determining the position of said stop, of course), when getting close to said limit position Xlim.

However, since it is not necessary to brake the mechanism 3 when getting away from the limit position Xlim, the safety threshold T7_safe may directly return back to its maximum value (plateau value), as illustrated by the rectangular corner-like shaped boundary of the authorized domain D1 in FIG. 4.

Preferably, the limit position Xlim is defined as a percentage, for example comprised between 75% and 100%, and more particularly between 80% and 95% of the position of the corresponding end-of-stroke stop S1, S2.

Of course, the invention also concerns as such a power steering system 1 allowing implementing all or part of the aforementioned characterization methods.

Thus, the invention concerns more particularly a power steering system 1 which comprises a characterization module 13 forming a complete characterization «toolbox», containing and allowing implementing an exploration cycle selectively among a plurality of available exploration cycles, said plurality of available cycles. Thus, the invention concerns a power steering system 1 intended to equip a vehicle and comprising at least one heading definition device 2, such as a steering wheel, which enables a driver to define a steering angle A1 of the power steering system, a steering mechanism 3 provided with at least one movable member 4, such as a rack, whose position P4 adapts so as to correspond to the selected steering angle A1, as well as at least one assist motor 7 arranged so as to be able to drive said steering mechanism 3, said power steering system 1 including on the one hand a first onboard module 8, called «assist module» 8, which contains a first set of functions called «assist laws», which allow generating, when the power steering system 1 is dedicated to driving of a vehicle, piloting setpoints towards the assist motor 7, in order to make said vehicle follow a path that is determined according to the situation of said vehicle with respect to its environment, and on the other hand a second onboard module 13, called «characterization module» 13, which contains a second set of functions, called «characterization functions», distinct from the assist laws, and which allow implementing, during a period where the power steering system is not dedicated to driving of a vehicle, and automatically, a characterization method intended to empirically determine at least one property of said power steering system, called «pursued property».

Like the assist module 8, the characterization module 13 preferably consists of an electronic or computer module.

As indicated hereinabove, said characterization method comprises a step (a) of automatically activating the assist motor 7, during which the second onboard module 13 automatically generates and applies to the assist motor 7, without requiring any external action on the heading definition device 2, an activation setpoint T7, V7, P7 which follows one or several pre-established cycle(s) called «exploration cycles» CY, in order to enable a measurement step (b), according to which is measured, during the exploration cycle(s) CY or on completion of said exploration cycle(s) CY, at least one physical parameter, called «indicator parameter» P7_mes, T7_mes, P4_mes, T2_mes, V2_mes, etc., which is specific to the response supplied by the power steering system 1 to the automatic activation of the assist motor 7 and which is characteristic of the pursued property, then an analysis step (c), during which the pursued property is quantified from the measurement(s) of the indicator parameter.

Hence, the characterization module 13, as well as the assist module 8, will preferably be integrated to the steering system 1, and in particular integrated to an onboard calculation module which may be used in a standalone manner.

The characterization functions, and more particularly the exploration cycles CY that these characterization functions automatically implement, may advantageously be stored in a non-volatile memory of the characterization module 13, for example in the form of libraries of functions (dll files) programmed in said characterization module 13 and/or mappings («maps»).

Thus, the characterization module 13 will contain a plurality of pre-established exploration cycles CY, for example so as to allow selectively activating, besides the vehicle piloting phase, a cycle CY selected from the exploration cycles described in the foregoing.

Preferably, the second onboard module (characterization module) 13 includes at least two, or at least three, at least four characterization functions among the following characterization functions, or all of said characterization functions, as these have been detailed in practice hereinabove with reference to the method:
a function of characterizing the position of an end-of-stroke stop S1, which uses a speed exploration cycle CY_speed during which a non-zero speed setpoint V7 is applied to the assist motor 7 in order to drive said assist motor 7 and the steering mechanism 3, in a first direction, until said steering mechanism 3 abuts on a first end-of-stroke stop S1;
a function of characterizing the sound level, which uses a speed exploration cycle CY_speed providing for a speed plateau 32, 132 where the servo-controlled speed is substantially constant;
a function of identifying the index position 10, 11, 12, which uses a speed exploration cycle CY_speed adapted to servo-control, by means of the assist motor 7, the rotational speed V2 of a steering wheel 2 according to a substantially constant speed plateau 32, 132 and over a stroke that is large enough to ensure the crossing, in the same direction of displacement, of at least one index position, or at least two index positions, each associated to a complete revolution of said steering wheel.

Preferably, the characterization module 13 will also comprise a selector allowing selecting and executing either one of said available characterization functions, separately from the other characterization functions and assist functions, and thus control automatically, and in a standalone manner, the assist motor 7 for characterization, independently of the piloting of the vehicle.

Of course, the invention is not limited to the sole variants described in the foregoing, those skilled in the art being in particular able to freely isolate or combine together the aforementioned features, or substitute them with equivalents.

1. A method for characterizing a power steering system intended to empirically determine at least one property of said power steering system, called «pursued property», said power steering system comprising at least one heading definition device, which allows defining the orientation, called «steering angle» of the power steering system, a steering mechanism provided with at least one movable member, whose position adapts so as to correspond to the selected steering angle, as well as at least one assist motor arranged so as to be able to drive said steering mechanism, said method comprising, besides a piloting phase during which the power steering system is dedicated to driving of a vehicle in order to make said vehicle follow a path that is determined according to the situation of said vehicle with respect to its environment, a step (a) of automatically activating the assist motor, during which a calculator is used to automatically generate and apply to the assist motor, without requiring any external action on the heading definition device, an activation setpoint which follows one or several pre-established cycle(s) called «exploration cycles», a measurement step (b), according to which is measured, during the exploration cycle(s) or on completion of said exploration cycle(s), at least one physical parameter, called «indicator parameter», which is specific to the response supplied by the power steering system to the automatic activation of the assist motor and which is characteristic of the pursued property, then an analysis step (c), during which the pursued property is quantified from the measurement(s) of the indicator parameter, the method being wherein, during the automatic activation step (a), a speed exploration cycle or a succession of several speed exploration cycles is applied, where each speed exploration cycle servo-controls the speed of the assist motor and/or of a selected movable member of the steering mechanism.

2. The characterization method according to claim 1, wherein in order to identify at least one position of a first end-of-stroke stop of the steering mechanism and/or one position of a second end-of-stroke stop of said steering mechanism opposite to the first end-of-stroke stop, and/or the maximum stroke of the movable member corresponding to the distance between said first and second end-of-stroke stops and/or the central position of said movable member located halfway between said two end-of-stroke stops, and in that, to this end, during the automatic activation step (a), the speed exploration cycle applies a non-zero speed setpoint, in a first direction, until the steering mechanism is stopped by the first end-of-stroke stop, and/or applies, respectively, a non-zero speed setpoint, in a second direction, until the steering mechanism is stopped by the second end-of-stroke stop.

3. The characterization method according to claim 1, wherein it is used to identify an acoustic property of the power steering system and, in that, to this end, a noise indicator parameter, representing the sound level of the assist motor and/or of the steering mechanism, is measured during the measurement step (b), while the speed exploration cycle is applied.

4. The characterization method according to claim 1, wherein it is used to identify a dynamic property of the power steering system amongst: the existence of one or several possible sticking point(s), or a value of an internal friction of the steering mechanism and affecting the displacement of the movable member, and in that, to this end, during the measurement step (b), is measured a force indicator parameter, representing the force supplied by the assist motor, while the speed exploration cycle is applied and, during the analysis step (c), a sticking point is identified when it is detected that the force indicator reaches or exceeds a predetermined warning threshold, respectively the friction is assessed from the drop of the force indicator at the time of the steering reversal.

5. The characterization method according to claim 1, wherein, the heading definition device comprising a steering wheel whose rotation is related to the displacement of the steering mechanism, and said steering wheel being provided with an index, which marks a unique reference position in a complete revolution of said steering wheel, said method is used to identify, in a reference frame associated to the assist motor, one or several position(s) of passage of the steering wheel through said index, in that the speed exploration cycle is defined to this end so as to create a plateau of the rotational speed of the steering wheel, which extends from a plateau start position up to a plateau end position, and according to which the servo-controlled rotational speed of the steering wheel is constantly and automatically maintained, between the plateau start position and the plateau end position, in the vicinity of a plateau nominal value, with an error less than 20%, of said plateau nominal value, and in that the plateau start and plateau end positions are selected such that the plateau covers a range of positions which is large enough to perform at least one passage(s) through the index in a first direction of displacement.

6. The characterization method according to claim 1, wherein it allows determining at least one pursued property amongst:
a friction value specific to the steering system and which resists the displacement of a movable member of said steering system, for example of a rack,
a measurement of the stroke of a steering rack,
an identification of the positions of the end-of-stroke stops of the steering mechanism,
an identification of the central position of the steering mechanism, located halfway between the end-of-stroke stops,
an identification of one or several index position(s), signaled by an index which marks a unique reference position throughout the same complete revolution of a steering wheel,
a sound level generated by the assist motor and/or the steering mechanism,
the identification of positions called «sticking points» at the level of which the steering mechanism has a resistance to the displacement, higher than a predetermined threshold.

7. A power steering system intended to equip a vehicle and comprising at least one heading definition device, which enables a driver to define a steering angle of the power steering system, a steering mechanism provided with at least one movable member, such as a rack, whose position adapts so as to correspond to the selected steering angle, as well as at least one assist motor arranged so as to be able to drive said steering mechanism, said power steering system including on the one hand a first onboard module, called «assist module», which contains a first set of functions called «assist laws», which allow generating, when the power steering system is dedicated to driving of a vehicle, piloting setpoints towards the assist motor, in order to make said vehicle follow a path which is determined according to the situation of said vehicle with respect to its environment, and on the other hand, a second onboard module, called «characterization module», which contains a second set of functions, called «characterization functions», distinct from the assist laws, and which allow implementing, during a period where the power steering system is not dedicated to driving of a vehicle, and automatically, a characterization method intended to empirically determine at least one property of said power steering system, called «pursued property», said characterization method comprising a step (a) of automatically activating the assist motor during which the second onboard module automatically generates and applies to the assist motor, without requiring any external action on the heading definition device, an activation setpoint which follows one or several pre-established cycle(s) called «exploration cycles», in order to enable a measurement step (b), according to which is measured, during the exploration cycle(s) or on completion of said exploration cycle(s), at least one physical parameter, called «indicator parameter», which is specific to the response supplied by the power steering system to the automatic activation of the assist motor and which is characteristic of the pursued property, then an analysis step (c), during which the pursued property is quantified from the measurement(s) of the indicator parameter, wherein during the automatic activation step (a), a speed exploration cycle, or a succession of several speed exploration cycles, is applied, where each speed exploration cycle servo-controls the speed of the assist motor and/or of a selected movable member of the steering mechanism.

8. The power steering system according to claim 7, wherein the second onboard module includes at least two characterization functions among the following characterization functions:
a function of characterizing the position of an end-of-stroke stop, which uses a speed exploration cycle during which a non-zero speed setpoint is applied to the assist motor in order to drive said assist motor and the steering mechanism, in a first direction, until said steering mechanism abuts on a first end-of-stroke stop;
a function of characterizing the sound level, which uses a speed exploration cycle providing for a speed plateau where the servo-controlled speed is substantially constant;
a function of identifying the index position, which uses a speed exploration cycle adapted to servo-control, by means of the motor, the rotational speed of a steering wheel according to a substantially constant speed plateau and over a stroke that is large enough to ensure the crossing, in the same direction of displacement, of at least one index position, or at least two index positions, each associated to a complete revolution of said steering wheel.
